(19) United States
(12) Patent Application Publication
(10) Pub. No.: US 2017/0282986 A1
(43) Pub. Date: Oct. 5, 2017

(54) ELECTRICALLY CONTROLLABLE SEAT POST

(71) Applicant: GIANT MANUFACTURING CO., LTD., Taichung City (TW)

(72) Inventors: Shu-Yu JHOU, Taipei City (TW); Che-Wei HSU, New Taipei City (TW); I-Teh CHEN, Taichung City (TW)

(21) Appl. No.: 15/472,305

(22) Filed: Mar. 29, 2017

(30) Foreign Application Priority Data
Apr. 1, 2016 (TW) 105204620

(51) Int. Cl. B62J 1/08; F15B 15/20

(52) U.S. Cl. CPC B62J 1/08; F15B 15/202; B62J 2001/085

(57) ABSTRACT

An electrically controllable seat post is provided. The electrically controllable seat post includes a retractable rod and a switch actuator. The retractable rod includes a switch. The switch actuator is corresponding to the switch and includes a pushing member, an electromagnetic coil and a controller. The pushing member is assembled in the switch actuator, wherein the pushing member is controlled to move to open or close the switch. The electromagnetic coil generates a magnetic force by injecting a current therethrough, wherein the pushing member is moved by the magnetic force. The controller controls the switch actuator.

### RELATED APPLICATIONS

This application claims priority to Taiwan Application Serial Number 105204620, filed Apr. 1, 2016 which is herein incorporated by reference.

### BACKGROUND

### Technical Field

The present disclosure relates to a retractable seat post. More particularly, the present disclosure relates to an electrically controllable and retractable seat post that has higher retracting speed and stroke.

### Description of Related Art

Owing to the increasing demands of the bike riders, a seat post that with a height-adjustable rod (saddle) has been reached in the market. Conventionally, the height of this kind of retractable seat post can be manually controlled to adapt to variant road conditions. For example, the saddle can be lowered by adjusting the height of the retractable seat post while riding downhill. Therefore, the center of gravity can be lowered so that the handling can be enhanced and the foot can touch the ground to assist to turn around the corner. This kind of retractable seat post is suitable for mountain biking or hillwood road biking owing to its capability of overcoming uncertainties of a rough road.

A kind of retractable seat post is wire-controlled. An exposed wire is connected to the handle bar and the retractable seat post under the saddle, and a lever or other linkage mechanism is used to open a hydraulic or a pneumatic valve thereby elongating or contracting the retractable seat post. However, no matter the wire is exposed out or not, interference or friction of the wire will commonly occur.

Another kind of retractable seat post with electricity controllability has been developed. In this kind of seat post, a motor is used to activate a hydraulic valve or a pneumatic valve. In this kind of seat post, issues on wire interference or friction can be eliminated; however, other issues are raised. For example, a sufficient torque is required to open the hydraulic valve or the pneumatic valve, and since a rotation speed is inversely proportional to a torque in a motor, the response time of the motor to produce sufficient torque is too low to reflect the road condition immediately. Furthermore, an extra device (e.g. a gear box) is also required to be assembled with the motor, thus bringing the inconvenience on assembling. In other word, this kind of motor-driven seat post can eliminate wire interference or friction issue of the wire-controlled seat post, but will raise new issues on low response speed and inconvenience of assembling.

Therefore, there is a need to develop a novel seat post that has low response time and is easy to assemble.

### SUMMARY

According to one aspect of the present disclosure, an electrically controllable seat post is provided. The electrically controllable seat post includes a retractable rod and a switch actuator. The retractable rod includes a switch. The switch actuator is corresponding to the switch and includes a pushing member, an electromagnetic coil and a controller. The pushing member is assembled in the switch actuator, wherein the pushing member is controlled to move to open or close the switch. The electromagnetic coil generates a magnetic force by injecting a current therethrough, wherein the pushing member is moved by the magnetic force. The controller controls the switch actuator.

### BRIEF DESCRIPTION OF THE DRAWINGS

The present disclosure can be more fully understood by reading the following detailed description of the embodiment, with reference made to the accompanying drawings as follows:

FIG. 1 is a cross-sectional view of an electrically controllable seat post according to a first embodiment of the present disclosure;

FIG. 2 is a lateral cross-sectional view of a saddle of the electrically controllable seat post of FIG. 1;

FIG. 3 is a longitudinal cross-sectional view of the saddle of the electrically controllable seat post of FIG. 2;

FIG. 4 is a cross-sectional view of a saddle of an electrically controllable seat post according to a second embodiment of the present disclosure;

FIG. 5 is a cross-sectional view of a saddle of an electrically controllable seat post according to a third embodiment of the present disclosure;

FIG. 6 is a cross-sectional view of a saddle of an electrically controllable seat post according to a fourth embodiment of the present disclosure;

FIG. 7 is a cross-sectional view of a saddle of an electrically controllable seat post according to a fifth embodiment of the present disclosure;

FIG. 8 is a cross-sectional view of a saddle of an electrically controllable seat post according to a sixth embodiment of the present disclosure;

FIG. 9 is a cross-sectional view of a saddle of an electrically controllable seat post according to a seventh embodiment of the present disclosure;

FIG. 10 is a cross-sectional view of a saddle of an electrically controllable seat post according to an eighth embodiment of the present disclosure;

FIG. 11 is a longitudinal cross-sectional view of the saddle of the electrically controllable seat post of FIG. 10;

FIG. 12 is a cross-sectional view of a saddle of an electrically controllable seat post according to a ninth embodiment of the present disclosure;

FIG. 13 is a cross-sectional view of an electrically controllable seat post according to a tenth embodiment of the present disclosure;

FIG. 14 is a schematic view showing that a pushing member is rotated to open a switch according to an eleventh embodiment of the present disclosure;

FIG. 15 is a schematic view shows that the pushing member is rotated to open the switch of FIG. 14;

FIG. 16 shows an operation procedure of an electromagnetic coil and two pushing members;

FIG. 17 shows another operation procedure of the electromagnetic coil and the two pushing members of FIG. 16; and

FIG. 18 a schematic view of an angle limitation mechanism of a pushing member according to a twelfth embodiment of the present disclosure.

### DETAILED DESCRIPTION

It is a purpose of the present disclosure to provide an electrically controllable and retractable seat post that has no motor response delay and ease of assembling.

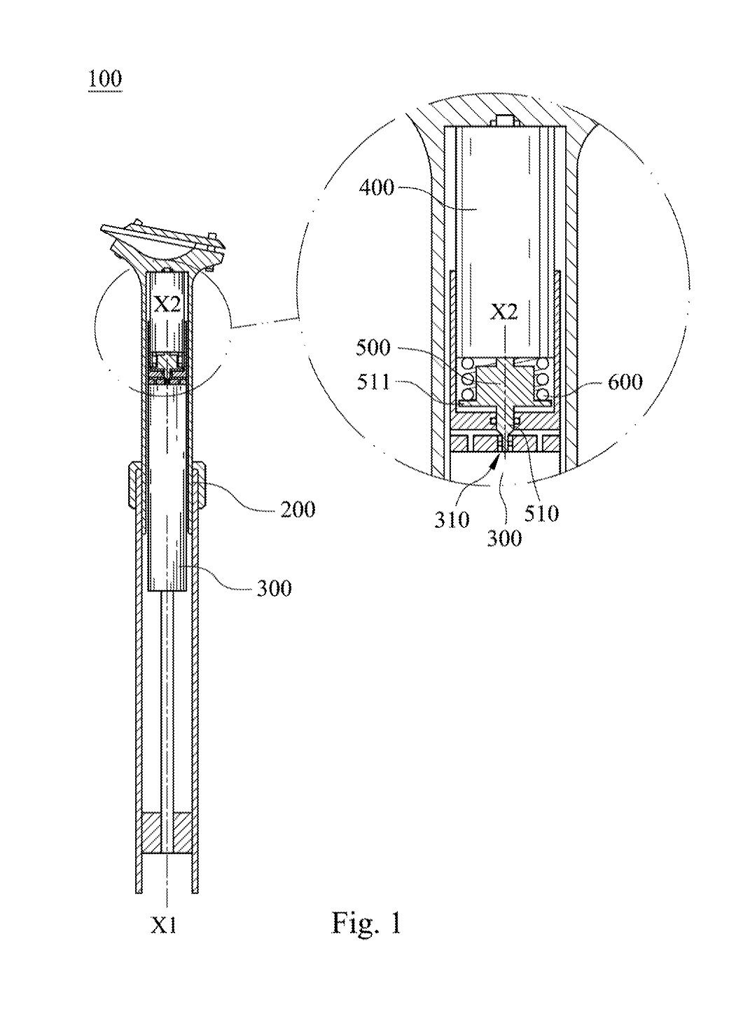

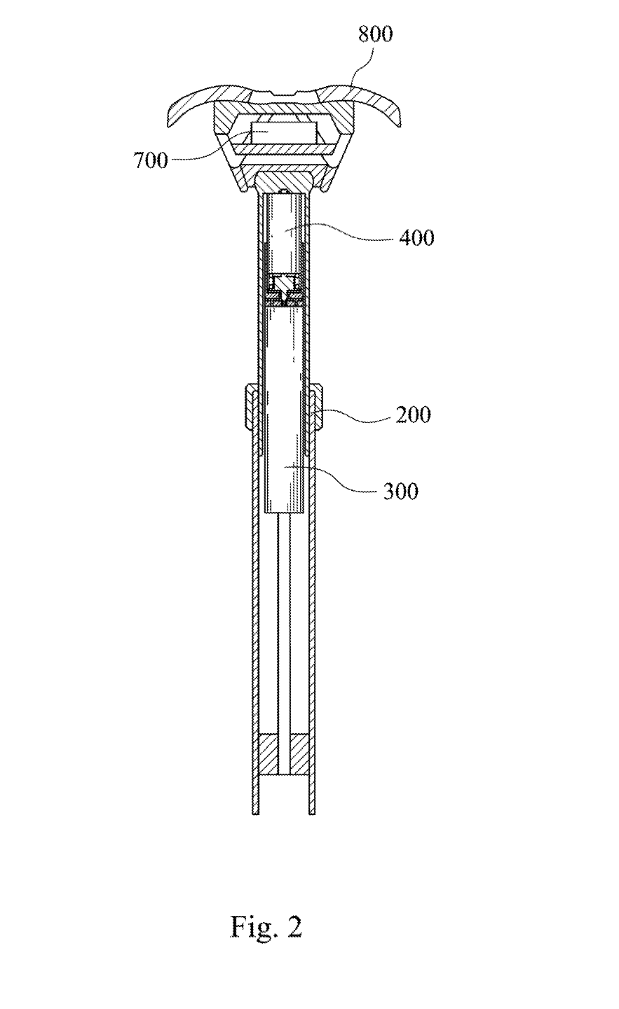

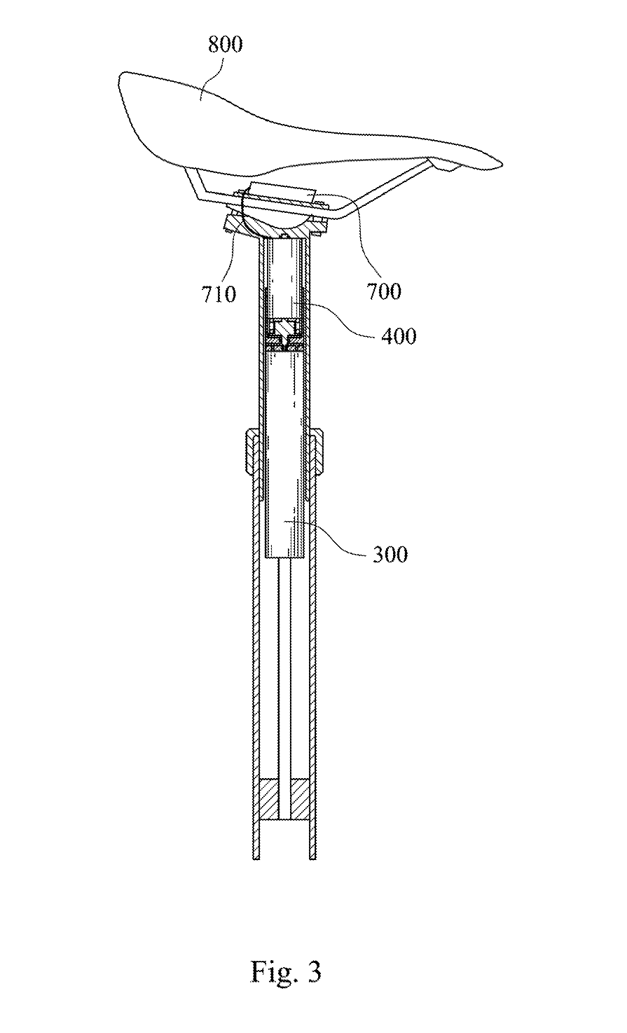

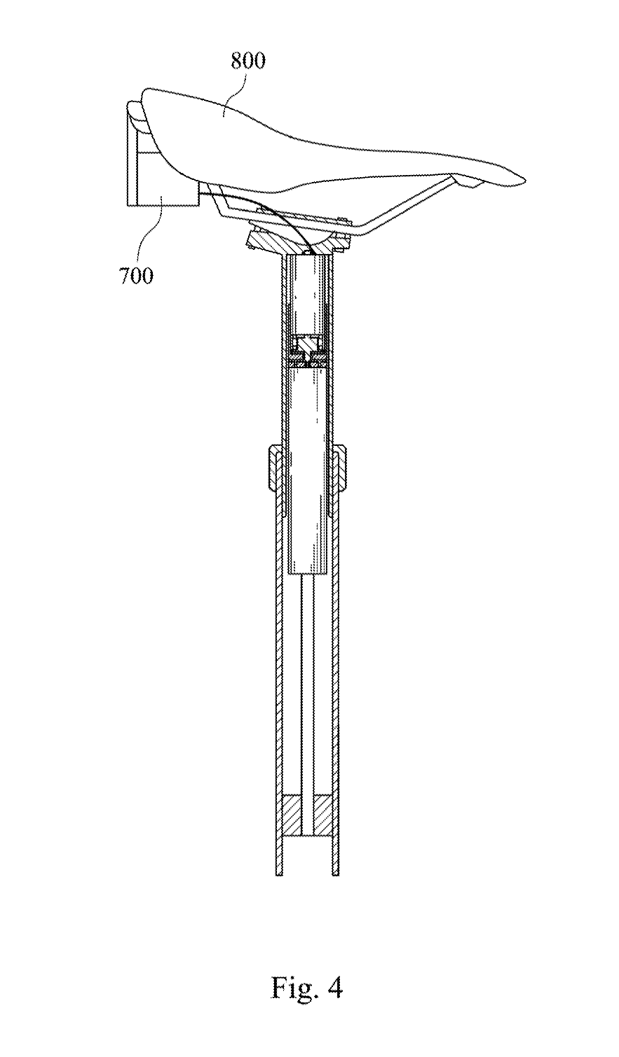

FIG. 1 is a cross-sectional view of an electrically controllable seat post according to a first embodiment of the present disclosure; FIG. 2 is a lateral cross-sectional view of a saddle of the electrically controllable seat post of FIG. 1; FIG. 3 is a longitudinal cross-sectional view of the saddle of the electrically controllable seat post of FIG. 2.

In the first embodiment, an electrically controllable seat post 100 includes a retractable rod 200, a cylinder 300, an electromagnetic coil 400, a pushing member 500, a recovering member 600 and a controller 700. The electromagnetic 400 and the pushing member 500 are operated corporately as a switch actuator (unnumbered).

The cylinder 300 is fixedly covered in the retractable rod 200. The cylinder 300 includes a switch 310 and a rod axis X1. A saddle 800 is assembled on the retractable rod 200. The switch 310 is used to trigger the elongation and contraction of the cylinder 300, and the elongation and contraction of the cylinder 300 drives the elongation and contraction of the retractable rod 200, thereby raising or lowering the saddle 800 instantly. The cylinder 300 can be a pneumatic cylinder, a hydraulic cylinder or a liquid-gas modularized cylinder; similarly, the retractable rod 200 can be a pneumatic rod, a hydraulic rod or a liquid-gas modularized rod. In the embodiment, the cylinder 300 is located inside of the retractable rod 200.

The electromagnetic coil 400 is assembled in the retractable rod 200 and is corresponding to the switch 310. A portion of the pushing member 500 is assembled in the electromagnetic coil 400. A central axis X2 of the pushing member 500 is parallel to the rod axis X1 of the cylinder 300. One end 510 of the pushing member 500 is linearly moved by the electromagnetic coil 510 to open or close the switch 310.

The recovering member 600 is made from an elastic material. The recovering member 600 provides a revering force to the end 510 of the pushing member 500 so that the pushing member 500 is recovered to its original position.

The controller 700 is assembled under the saddle 800. The controller 700 controls the electromagnetic coil 400 through a connecting wire 710.

In the aforementioned first embodiment, the central axis X2 of the pushing member 500 is parallel to the rod axis X1; therefore the switch 310 is triggered by the pushing member 500, which is linear activated by the electromagnetic coil 400. The controller 700 can control the electromagnetic coil 400 to trigger the switch 310 instantly. The recovering member 600 is used to provide the recovering force to the end 510 of the pushing member 500 to recover the pushing member 500 to its original position.

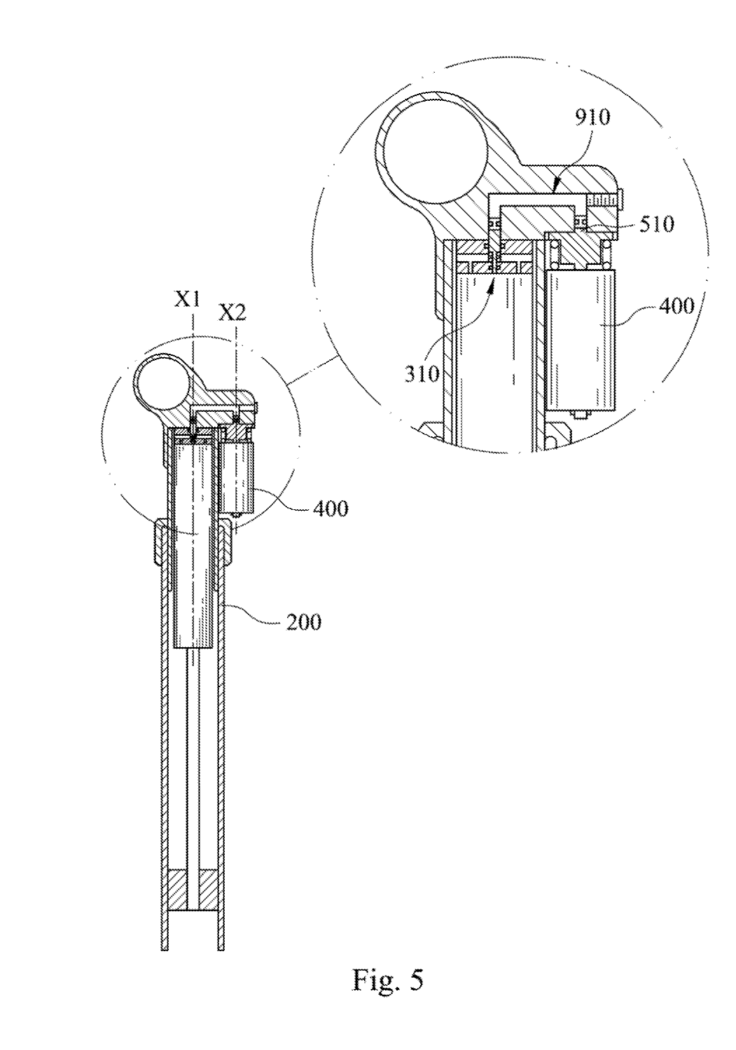

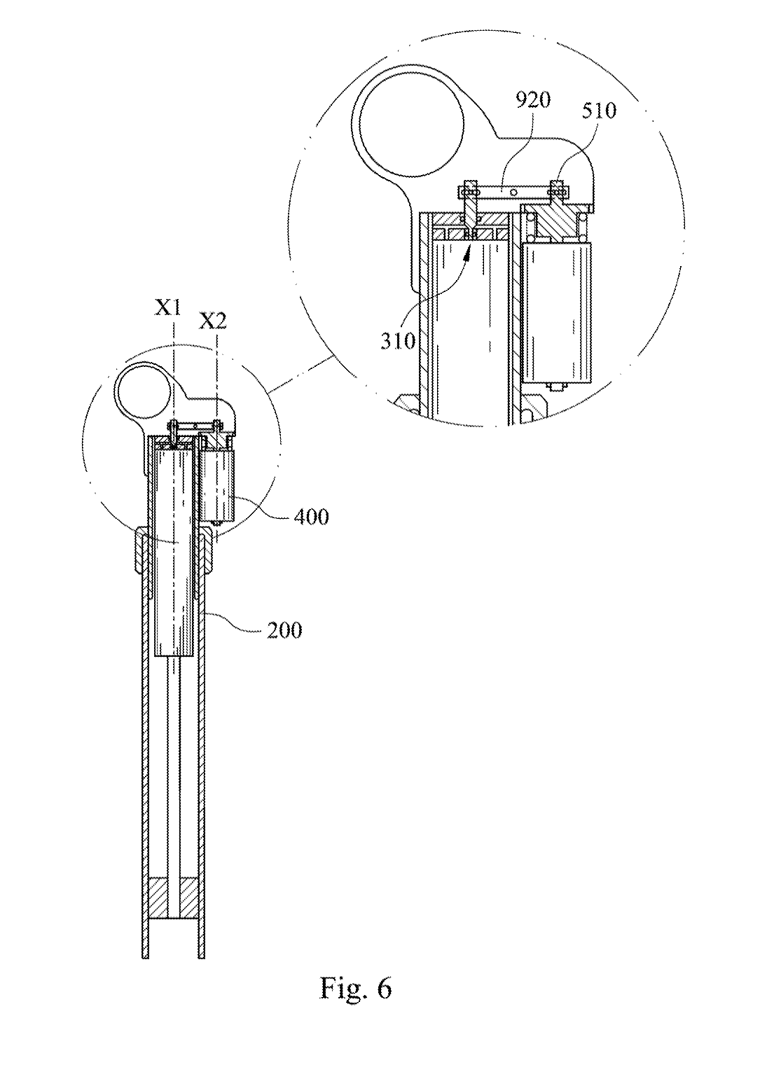

FIG. 5 is a cross-sectional view of a saddle of an electrically controllable seat post according to a third embodiment of the present disclosure; FIG. 6 is a cross-sectional view of a saddle of an electrically controllable seat post according to a fourth embodiment of the present disclosure.

In the third embodiment and the fourth embodiment, the end 510 is indirectly driven to trigger the switch 310, and the electromagnetic coil 400 is located outside of the retractable rod 200 and is assembled immediately adjacent to the retractable rod 200 to ensure that the central axis X2 is parallel to the rod axis X1.

In FIG. 5, an inverted-U shaped hydraulic linkage mechanism 910 is located between the end 510 and the switch 310 for triggering the switch 310. Conventionally, the hydraulic linkage mechanism 910 includes components such as oil route, piston and oil injection channel, etc., and there is no description herein.

In FIG. 6, a swing linkage mechanism 920 is located between the end 510 and the switch 310 for triggering the switch 310. Conventionally, the swing linkage mechanism 920 includes components such as a swing lever and a triggering lever, etc., and there is on description herein.

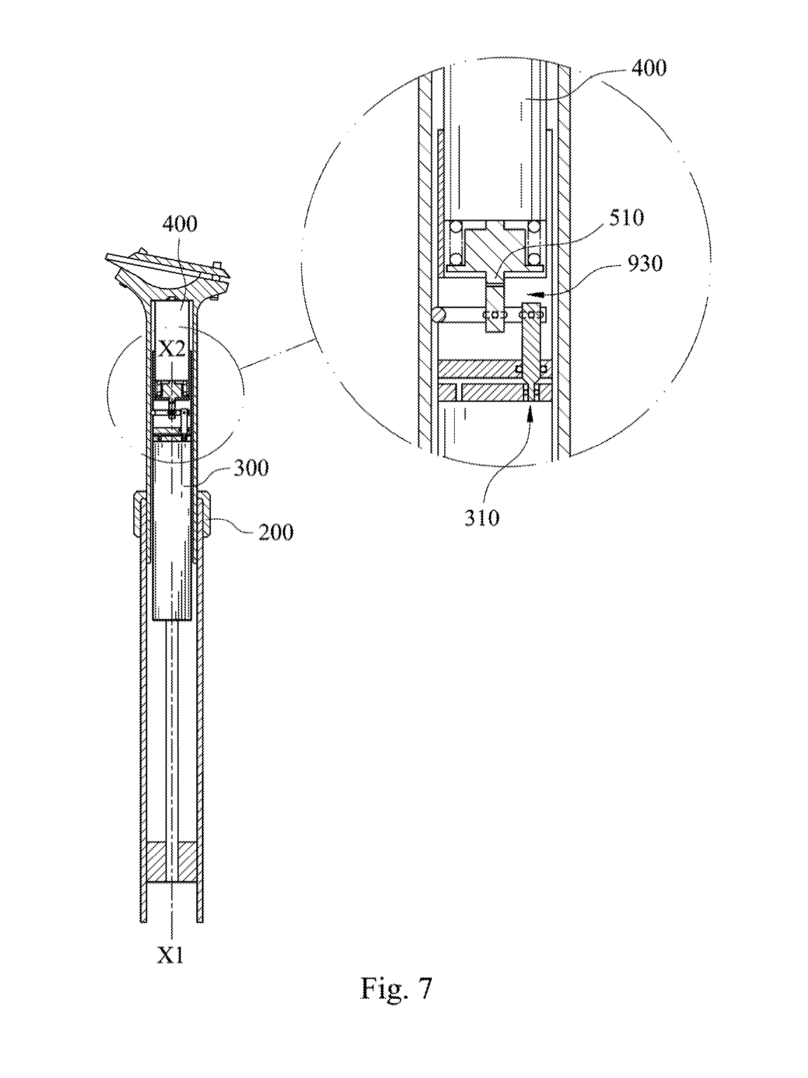

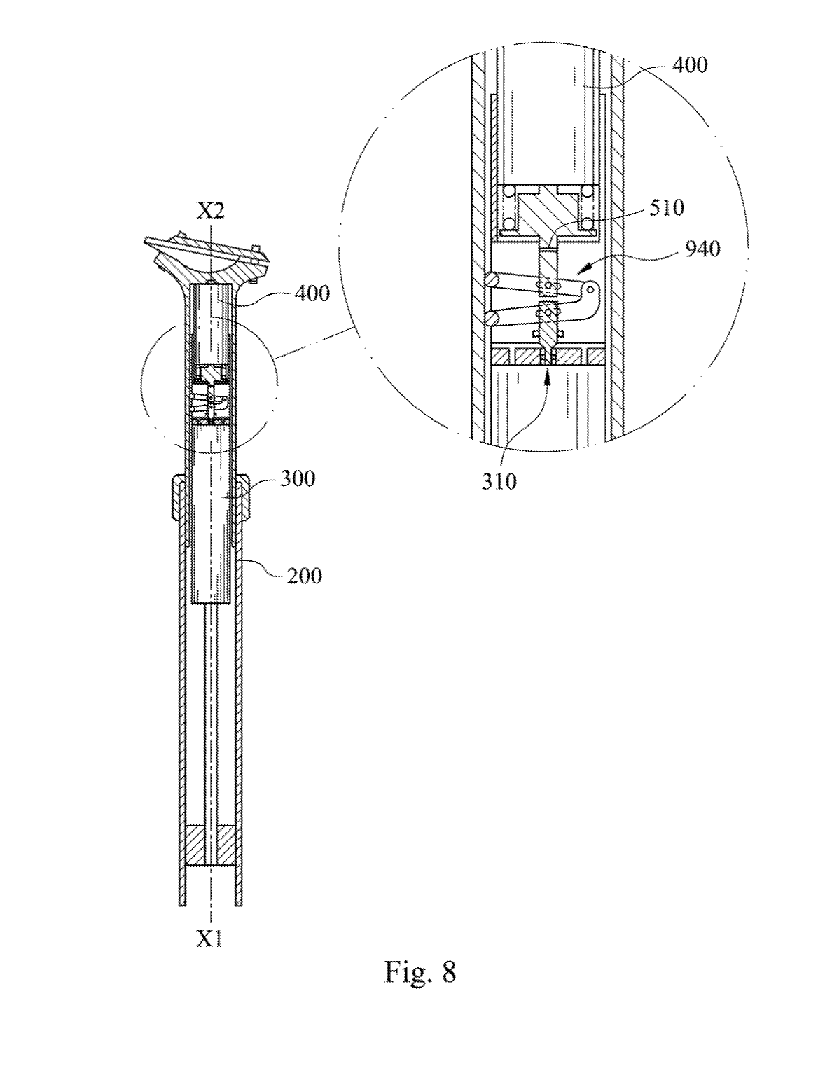

FIG. 7 is a cross-sectional view of a saddle of an electrically controllable seat post according to a fifth embodiment of the present disclosure; FIG. 8 is a cross-sectional view of a saddle of an electrically controllable seat post according to a sixth embodiment of the present disclosure.

In the fifth embodiment and the sixth embodiment, the central axis X2 and the rod axis X1 are coaxial, the end 510 is indirectly driven to trigger the switch 310, and the electromagnetic coil 400 is located inside of the retractable rod 200. The electromagnetic coil 400 is assembled at an upper end of the retractable rod 200 coaxially (upper end of the cylinder 300).

In FIG. 7, an L-shaped linkage mechanism 930 is used to trigger the witch 310. Conventionally, the linkage mechanism 930 includes components such as an L-shaped lever and a vertical triggering lever, etc., and there is on description herein. In FIG. 7, the end 510 and the switch 310 are not necessarily located in the same axis owing to the L-shaped linkage mechanism 930.

In FIG. 8, a close-type linkage mechanism 940 is located between the end 510 and the switch 310 for triggering the switch 310. Conventionally, the linkage mechanism 940 includes components such as double-inclined lever and a triggering lever, etc., and there is on description herein.

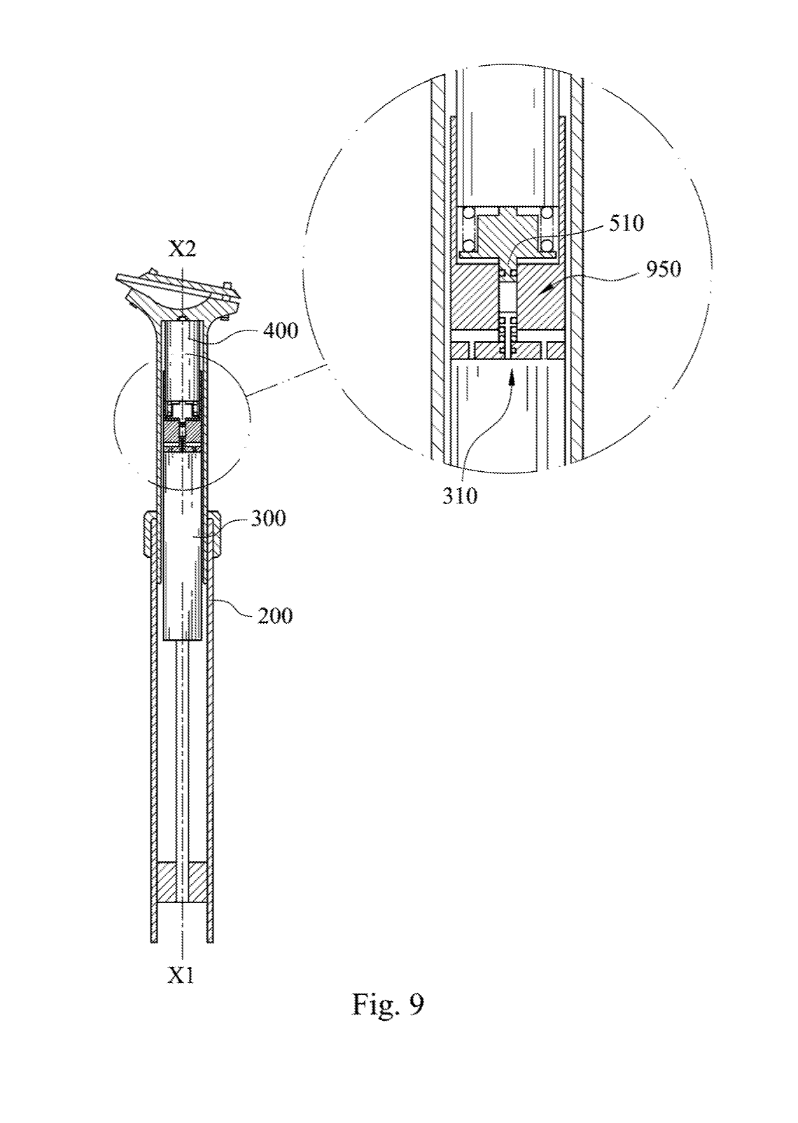

FIG. 9 is a cross-sectional view of a saddle of an electrically controllable seat post according to a seventh embodiment of the present disclosure.

In the seventh embodiment, the central axis X2 and the rod axis X1 are coaxial, the end 510 is indirectly driven to trigger the switch 310, and the electromagnetic coil 400 is located inside of the retractable rod 200. The electromagnetic coil 400 is assembled at an upper end of the cylinder 300. A vertical-type hydraulic linkage mechanism 950 is located between the end 510 and the switch 310 to trigger the switch 310. Conventionally, the vertical-type hydraulic linkage mechanism 950 includes components such as a vertical oil route and a piston, etc., and there is on description herein.

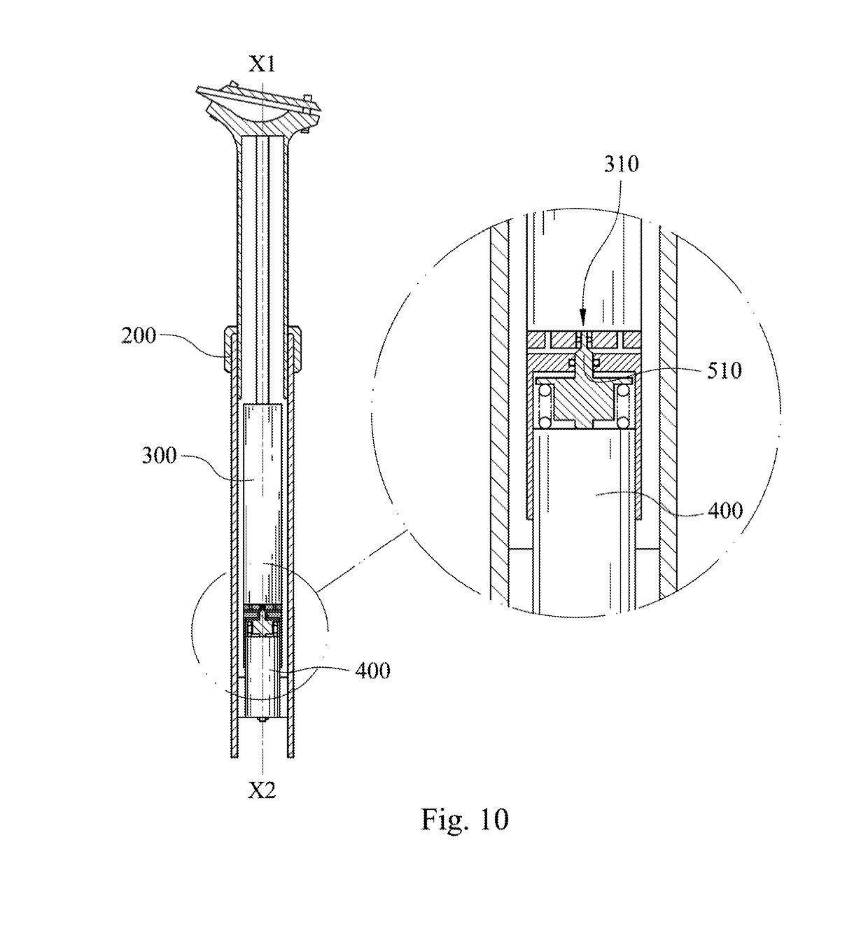

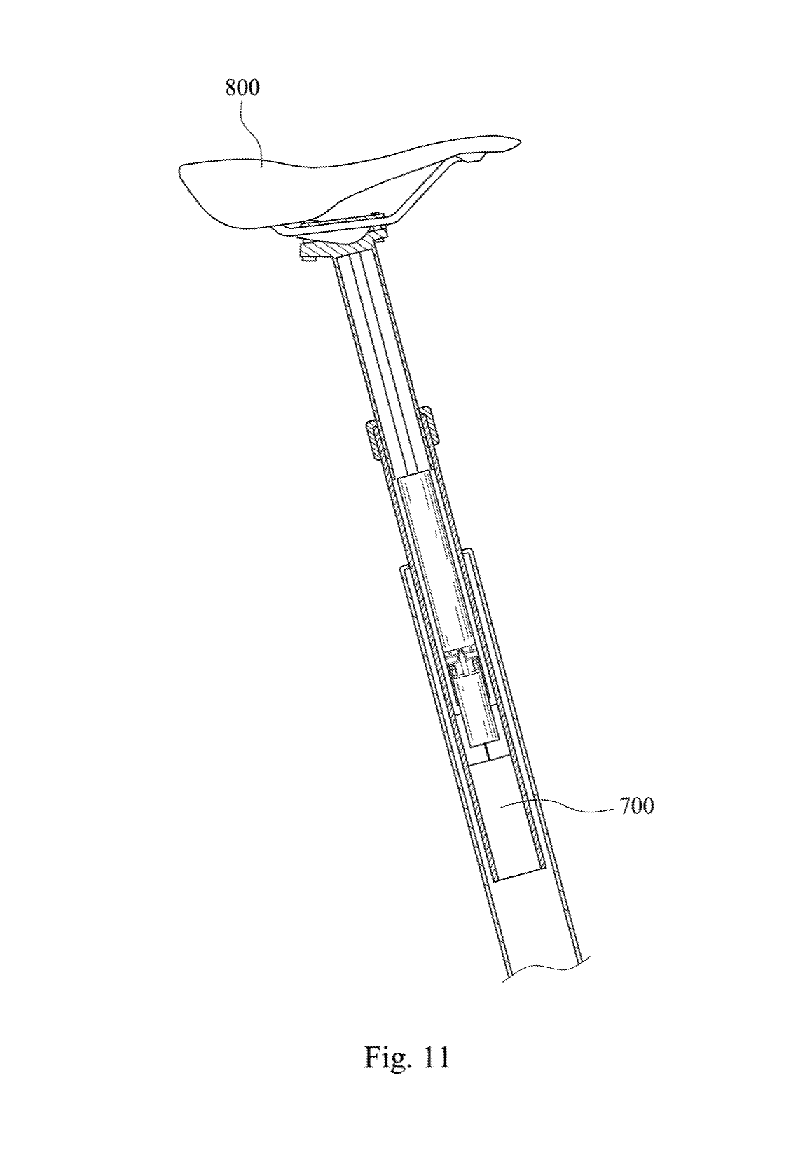

FIG. 10 is a cross-sectional view of a saddle of an electrically controllable seat post according to an eighth embodiment of the present disclosure; FIG. 11 is a longitudinal cross-sectional view of the saddle of the electrically controllable seat post of FIG. 10.

In the eighth embodiment, the central axis X2 and the rod axis X1 are coaxial, the end 510 is indirectly driven to trigger the switch 310, and the electromagnetic coil 400 is located inside of the retractable rod 200. The electromagnetic coil 400 is assembled at a bottom end of the cylinder 300. The controller 700 (and/or an electric controlling unit such as a battery and a chip, etc.) assembled in the retractable rod 200 can also be used to reduce the amount of components located under the saddle 800.

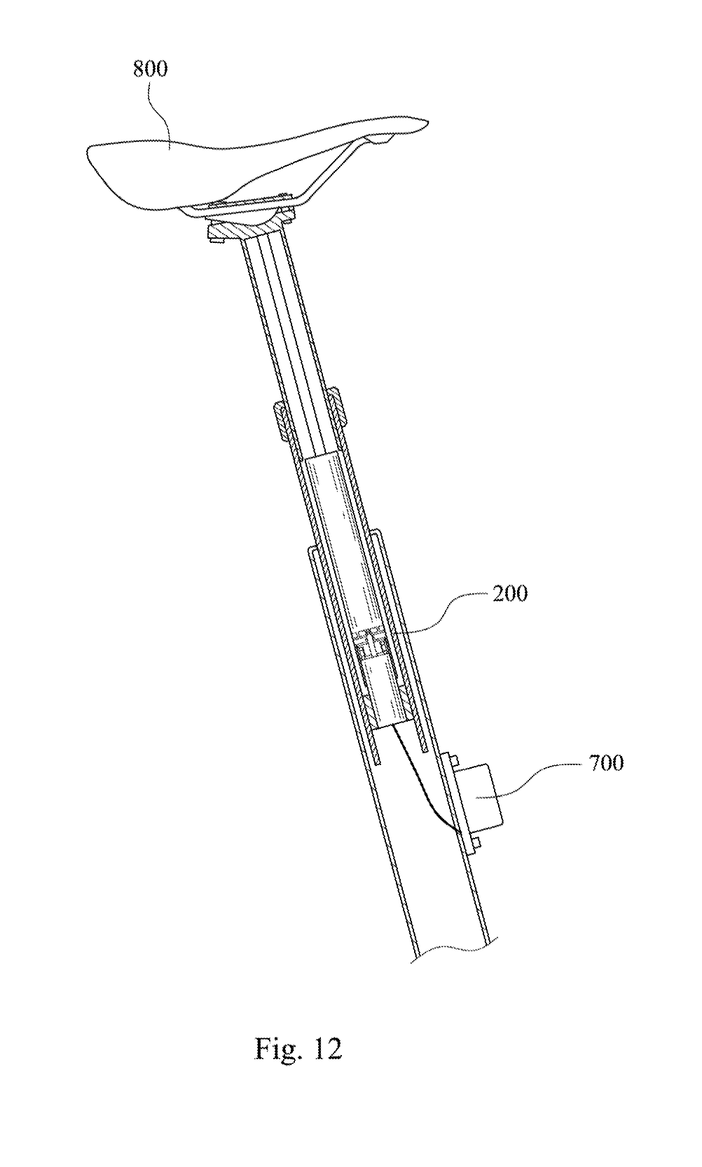

FIG. 12 is a cross-sectional view of a saddle of an electrically controllable seat post according to a ninth embodiment of the present disclosure.

In FIG. 12, the controller 700 (and/or an electric controlling unit such as a battery and a chip, etc.) is assembled outside of the retractable rod 200.

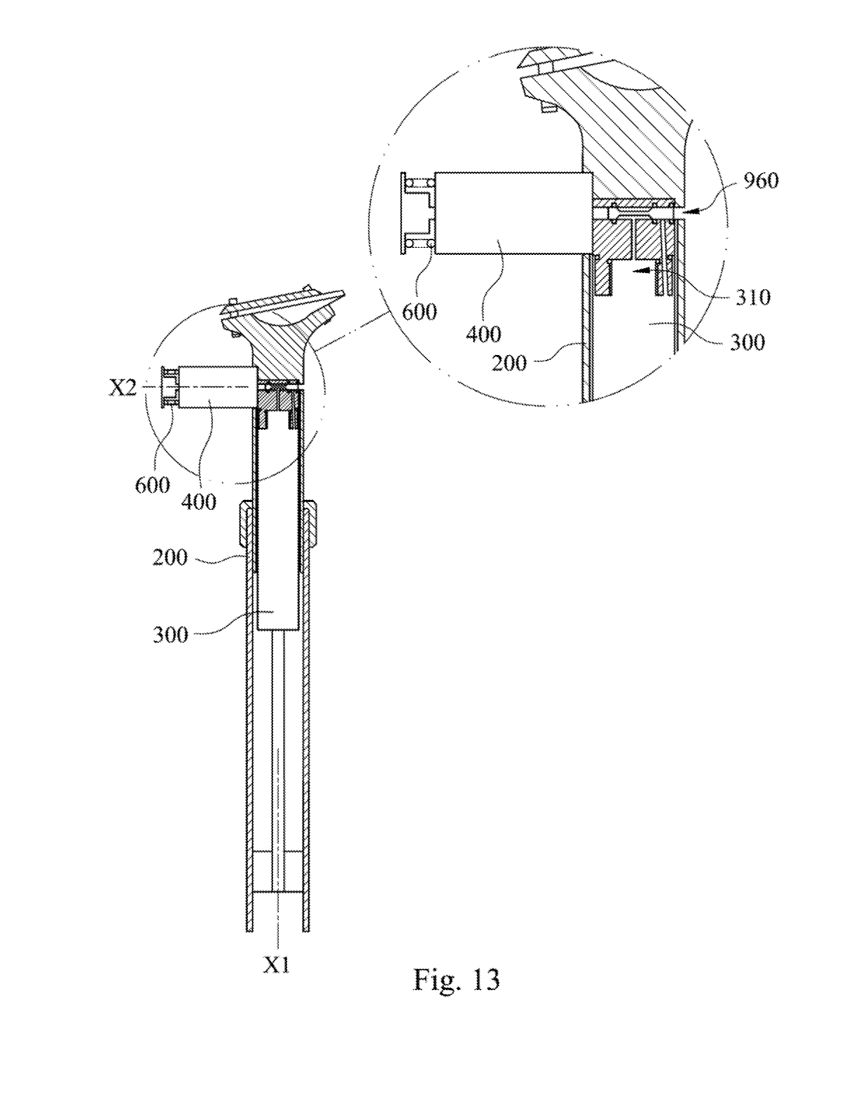

FIG. 13 is a cross-sectional view of an electrically controllable seat post according to a tenth embodiment of the present disclosure.

In FIG. 13, the electrically controllable seat post also includes the retractable rod 200, the electromagnetic coil 400 and the cylinder 300. In the tenth embodiment of FIG. 13, the central axis X2 and the rod axis X1 are vertically arranged, and an L-shaped hydraulic linkage mechanism 960 is corporate with the switch 310 to raise or lower the saddle. Conventionally, the linkage mechanism 960 includes components such as double oil routes and piston, etc., and there is no description herein. Furthermore, the recovering member 600 is located outside of the electromagnetic coil 400 to provide a recovering force.

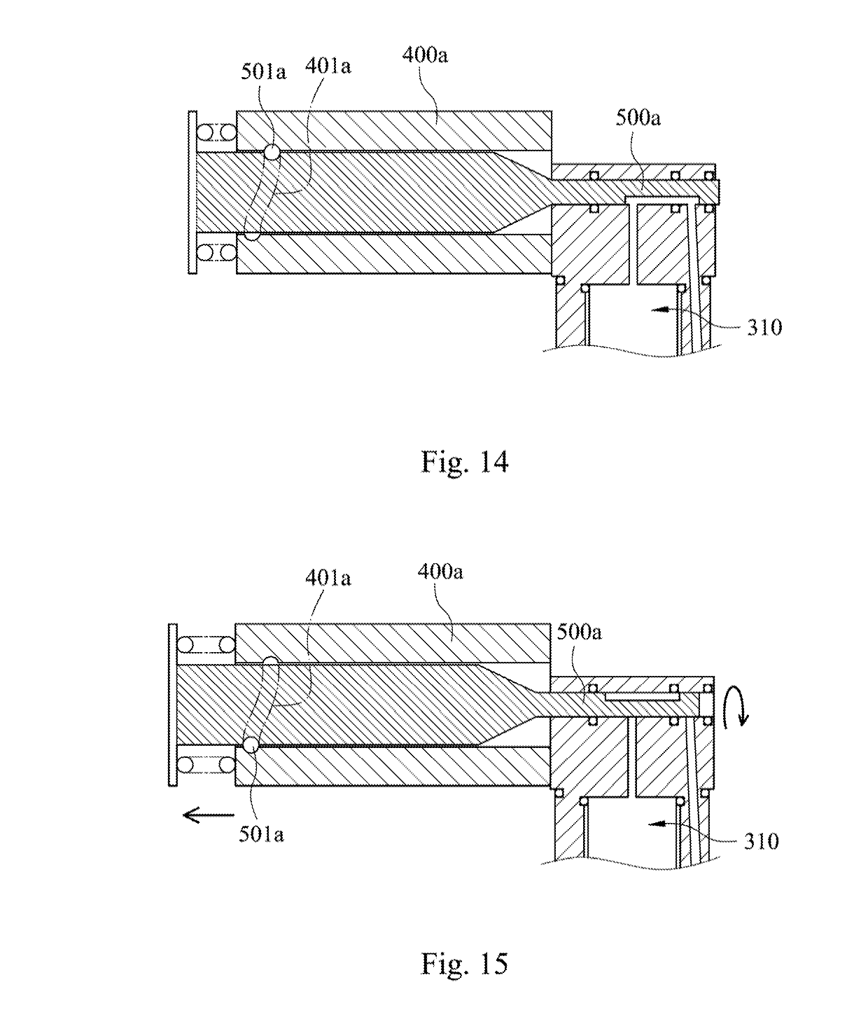

FIG. 14 is a schematic view showing that a pushing member is rotated to open a switch 310 according to an eleventh embodiment of the present disclosure; FIG. 15 is a schematic view showing that the pushing member is rotated to open the switch 310 of FIG. 14.

In the present disclosure, the pushing member 500 can be linearly moved as in the aforementioned embodiments; or a pushing member 500a can be rotated as in the eleventh embodiment of FIG. 14. The rotation of the pushing member 500a is formed by the corporation of a spiral groove 401a formed in an inner surface of the electromagnetic coil 400a with a protruding member 501a (a steel ball). When an elongation and contraction of the pushing member 500a is actuated by the electromagnetic coil 400a, the protruding member 501a slides in the spiral groove 401a to rotate the pushing member 500a. This kind of mechanism is to transfer a linear motion to a rotation motion and is a conventional technique.

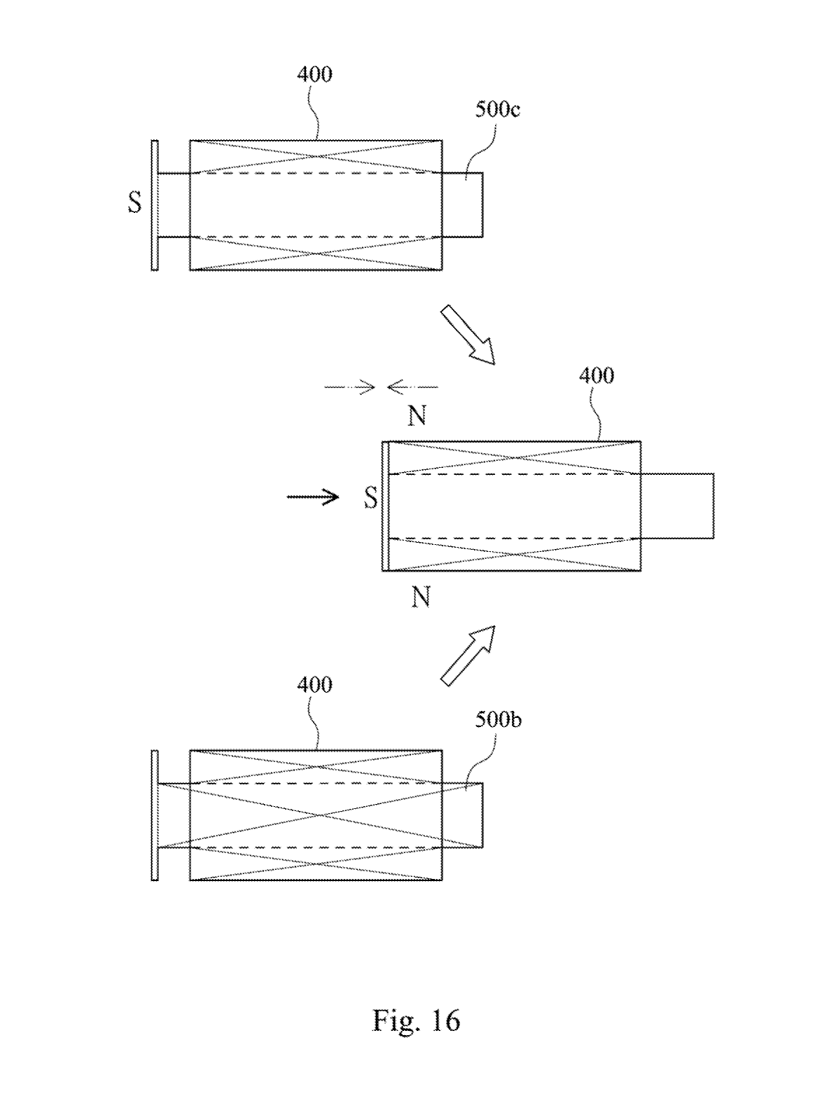

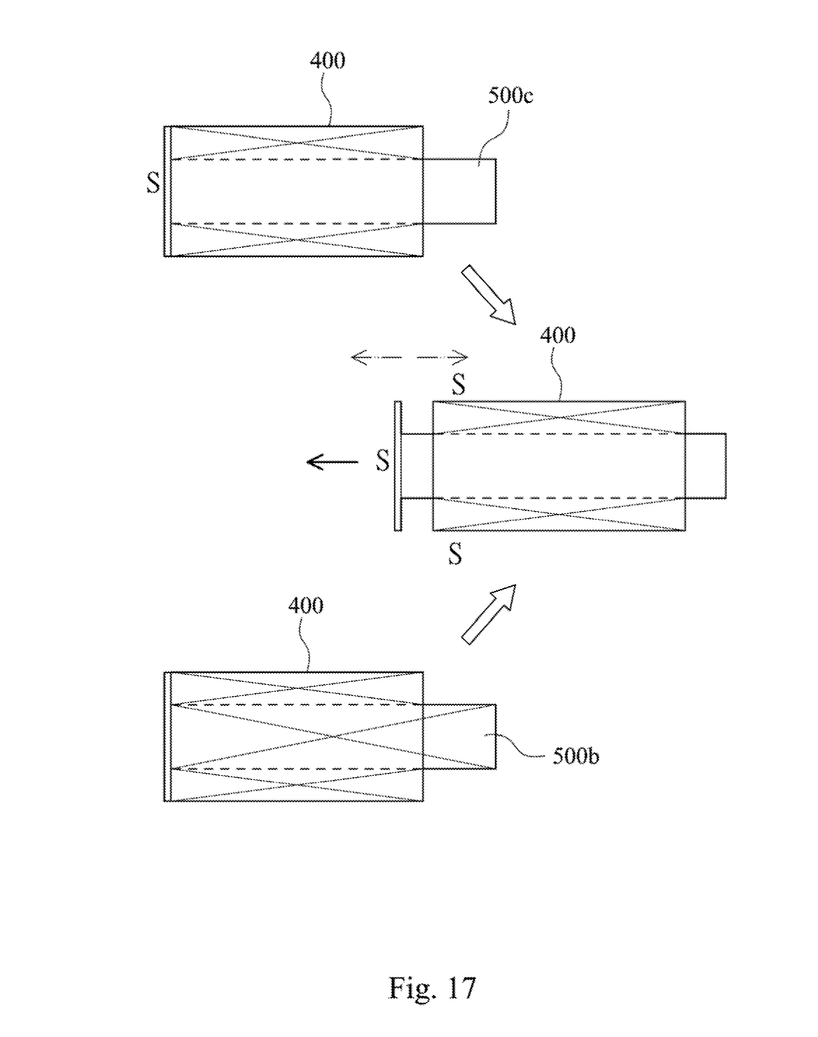

FIG. 16 shows an operation procedure of an electromagnetic coil and two pushing members; FIG. 17 shows another operation procedure of the electromagnetic coil and the two pushing members of FIG. 16.

In one embodiment, the pushing member can have a magnetic property. In FIG. 16, a pushing member 500c having a magnetic property at its end (functioned as an S pole in a magnetic field) and a pushing member 500b having no magnetic property are shown. The electromagnetic coil 400 and the pushing member 500b both have no magnetic field before injecting a current. When the current is injected to the electromagnetic coil 400, a corresponding N pole in a magnetic field is formed, and the pushing member 500b or the pushing member 500c is linearly moved owing to the repulsion of the magnetic field.

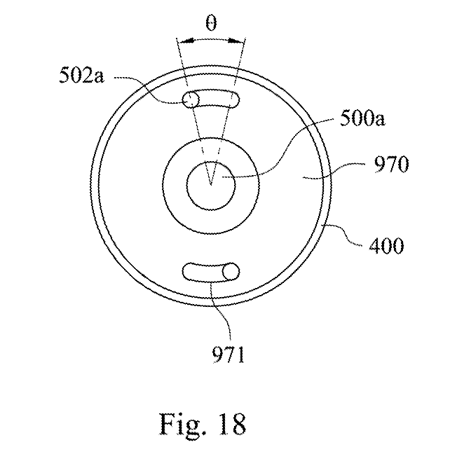

FIG. 18 a schematic view of an angle limitation mechanism of a pushing member according to a twelfth embodiment of the present disclosure.

In the twelfth embodiment of FIG. 18, an angle limitation mechanism 970 is assembled in the pushing member 500a. The pushing member 500a further includes two L-shaped limiting levers. The two limiting levers are assembled diagonally, and a front end of each of the limiting levers is protruded. The angle limitation mechanism 970 can be assembled at one end of the electromagnetic coil 400. The angle limitation mechanism 970 opens two curved openings 971, the front end of each of the limiting levers is position-limitedly swung in the curved openings 971 and a rotation angle θ of the pushing member 500a is constrained, thereby precisely controlling a movement of the pushing member 500a within the range of the rotation angle θ.

In sum, the present disclosure provides an electrically controllable seat post that using the switch actuator to activate an elongation and contraction of the retractable rod, and has advantages on wireless and precision control, rapid operation and minimizing cable routing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An electrically controllable seat post, comprising:
a retractable rod comprising a switch; and
a switch actuator corresponding to the switch and comprising:
a pushing member assembled in the switch actuator, wherein the pushing member is controlled to move to open or close the switch; and
an electromagnetic coil generating a magnetic force by injecting a current therethrough, wherein the pushing member is moved by the magnetic force; and
a controller controlling the switch actuator.

2. The seat post of claim 1, wherein the retractable rod comprises a cylinder, the cylinder is a pneumatic cylinder, a hydraulic cylinder or a liquid-gas modularized cylinder, and the switch is located on the cylinder.

3. The seat post of claim 1, wherein the retractable rod is a pneumatic rod, a hydraulic rod or a liquid-gas modularized rod.

4. The seat post of claim 1, wherein the switch is a valve and the pushing member is moved to open or close the valve.

5. The seat post of claim 1, wherein the switch is a button and the pushing member is moved to push the button.

6. The seat post of claim 1, wherein the pushing member is rotated to open or close the switch.

7. The seat post of claim 6, wherein the switch actuator comprises an inner surface, the inner surface comprises a spiral groove, the pushing member comprises a protruding member corresponding to the spiral groove, and when the pushing member is elongated or contracted, the protruding member slides in the spiral groove to rotate the pushing member synchronously.

8. The seat post of claim 1, wherein the retractable rod has a rod axis, and a moving direction of the pushing member is parallel to the rod axis.

9. The seat post of claim 1, wherein the retractable rod has a rod axis, and a moving direction of the pushing member is perpendicular to the rod axis.

10. The seat post of claim 1, wherein a linkage mechanism is located between the pushing member and the switch.

11. The seat post of claim 1, wherein the switch actuator is immediately adjacent to the retractable rod.

12. The seat post of claim 1, wherein the electromagnetic coil is located in the retractable rod.

13. The seat post of claim 1, wherein a hydraulic linkage mechanism is located between the pushing member and the switch.

14. The seat post of claim 1, wherein the electromagnetic coil is located at an end of the retractable rod.

15. The seat post of claim 1, further comprising a recovering member, wherein the recovering member is located between the electromagnetic coil and the pushing member for providing a recovering force.

16. The seat post of claim 6, wherein the pushing member comprises at least one protruded limiting lever, an angle limitation mechanism is assembled outside of the limiting lever, the angle limitation mechanism opens at least one curved opening, the limiting lever is position-limitedly swung in the curved opening, and a rotation angle of the pushing member is constrained by the corporation between the limiting lever and the curved opening.
